(19) United States
(12) Patent Application Publication
(10) Pub. No.: US 2008/0276147 A1
(43) Pub. Date: Nov. 6, 2008

(54) SYSTEM AND METHOD FOR PERFORMING A HARQ OPERATION IN AN OFDM-BASED RECEIVER

(76) Inventors: Gwang-Hyun Gho, Cupertino, CA (US); Kee-Bong Song, Santa Clara, CA (US); Won-Joon Choi, Cupetino, CA (US)

Correspondence Address: Wilson & Ham, 2530 Berryessa Road, PMB: 348, San Jose, CA, 95132, US

(21) Appl. No.: 12/114,967

(22) Filed: May 5, 2008

Related U.S. Application Data
(60) Provisional application No. 60/927,496, filed on May 4, 2007.

(51) Int. Cl. G08C 25/02; H04L 27/28; G06F 11/07

(52) U.S. Cl. 714/748; 375/260; 714/E11.024

(57) ABSTRACT

A system and method for performing a HARQ operation in an OFDM-based receiver utilizes a linked list scheme for a HARQ buffer, which is used to store soft information for HARQ entities with decoding errors. The device and method also combine soft information of a particular HARQ entity with previous updated soft information of the particular HARQ entity using a combined scaling factor that depends on a current scaling factor and a previous combined scaling factor.

### CROSS REFERENCE TO RELATED APPLICATION

This application claims benefit of U.S. Provisional Patent Application Ser. No. 60/927,496, filed on May 4, 2007, which is incorporated herein by reference.

### BACKGROUND OF THE INVENTION

Hybrid Automatic Repeat Request (HARQ) is a variation of the automatic repeat request (ARQ) error control method. In standard ARQ, error-detection (ED) information bits are added as overhead to the data, typically as a cyclic redundancy check (CRC). In HARQ, forward error correction (FEC) bits are also added to the ED bits, e.g., a Reed-Solomon code or Turbo code. HARQ performs better than ordinary ARQ in poor signal conditions, but this comes at the expense of significantly lower throughput in good signal conditions because of all the wasted overhead. A signal quality cross-over point occurs below which simple HARQ is preferable, and above which basic ARQ performs better.

There are several types of HARQs. In type II and type III HARQs, soft information bits of HARQ entities or channels are buffered and combined with soft information bits of the same HARQ entities in subsequent retransmissions, which minimizes the number of retransmissions. Depending on the type of HARQ, each retransmission may or may not contain same portion of encoded bits, so called chase combining and incremental redundancy scheme, respectively. High-Speed Downlink Packet Access (HSDPA) is one example of incremental redundancy scheme. For every retransmission, a coding gain is realized with the incremental redundancy, and time diversity gain is achieved with chase combining.

Typically, multiple HARQ entities are configured at the same time by the transmitter to achieve higher throughput by breaking whole information bits into smaller segments. When each HARQ entity can have a flexible number of soft bits at each new transmission, the receiver needs an efficient buffer management technique that requires minimal memory size. Also, when the retransmission happens over many frames, how to combine all the failed soft information while minimizing memory consumption becomes a complicated issue.

Thus, there is a need for a system and method for performing a HARQ operation that reduces complexity and memory size requirement.

### SUMMARY OF THE INVENTION

A system and method for performing a Hybrid Automatic Repeat Request (HARQ) operation in an OFDM-based receiver utilizes a linked list scheme for a HARQ buffer, which is used to store soft information for HARQ entities with decoding errors. The device and method also combine soft information of a particular HARQ entity with previous updated soft information of the particular HARQ entity using a combined scaling factor that depends on a current scaling factor and a previous combined scaling factor, which reduces complexity and memory requirement.

A HARQ system for an OFDM-based receiver in accordance with an embodiment of the invention comprises a HARQ processor, a HARQ buffer and a buffer controller. The HARQ processor is configured to process a plurality of HARQ entities of an incoming OFDM-based signal to determine whether there is a decoding error in any of the HARQ entities. The HARQ buffer is operably connected to the HARQ processor. The HARQ buffer is used to store soft information of a particular HARQ entity with the decoding error. The HARQ buffer includes a plurality of data memory blocks. Each of the data memory blocks includes a data portion and an address portion. The buffer controller is operably connected to the HARQ buffer. The buffer controller is configured to store segments of the soft information in some of the data portions of the data memory blocks of the HARQ buffer and associated linked addresses in some of the address portions of the data memory blocks of the HARQ buffer.

A method for performing a HARQ operation in an OFDM-based receiver comprises processing a plurality of HARQ entities of an incoming OFDM-based signal to determine whether there is a decoding error in any of the HARQ entities, and storing soft information of a particular HARQ entity with the decoding error in a HARQ buffer using a linked list, the HARQ buffer including a plurality of data memory blocks, each of the data memory blocks including a data portion to store a segment of the soft information bits and an address portion to store a linked address.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of an OFDMA wireless communication system in accordance with an embodiment of the invention.

FIG. 2 is a diagram of the data structure of a HARQ buffer in an OFDMA receiver of the OFDMA wireless communication system in accordance with an embodiment of the invention.

FIG. 3 is a process flow diagram of a HARQ buffer management method in accordance with an embodiment of the invention.

FIG. 4 is a process flow diagram of a method for performing a HARQ operation in an OFDM-based receiver in accordance with an embodiment of the invention.

### DETAILED DESCRIPTION

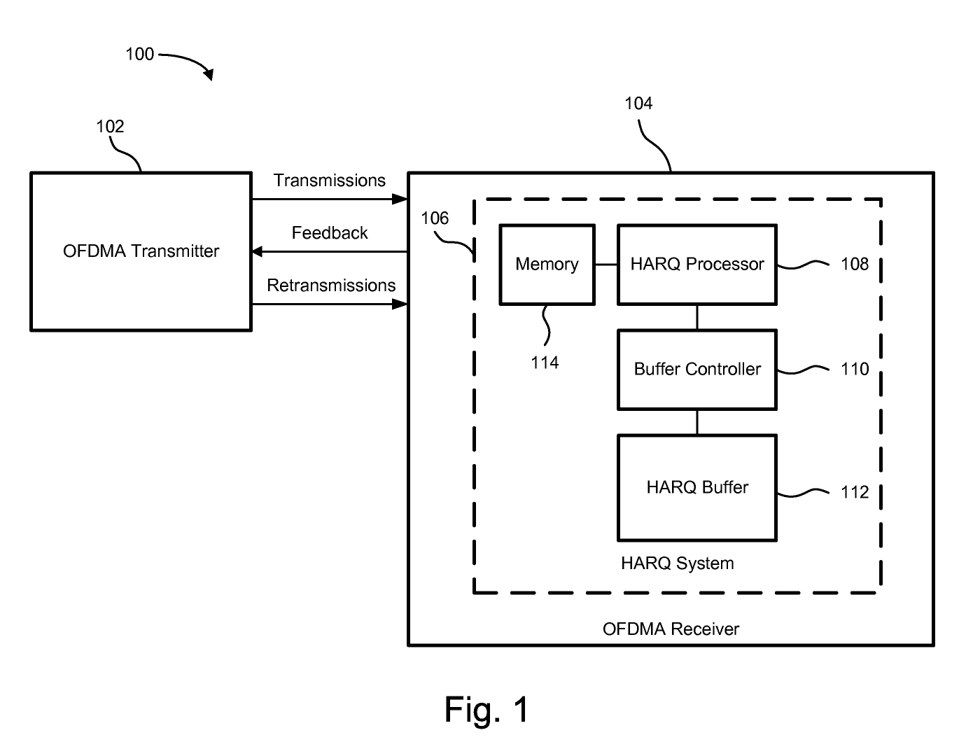

With reference to FIG. 1, an Orthogonal Frequency Division Multiple Access (OFDMA) wireless communication system 100 with Hybrid Automatic Repeat Request (HARQ) feature is described. The OFDMA wireless communication system 100 utilizes type II and type III HARQ schemes. The OFDMA wireless communication system 100 includes at least one OFDMA transmitter 102 and at least one OFDMA receiver 104. The OFDMA transmitter 102 may be part of a base station, while the OFDMA receiver 104 may be part of a mobile station. The OFDMA receiver 104 includes a HARQ system 106, which includes a HARQ processor 108, a buffer controller 110, a HARQ buffer 112 and memory 114. The OFDMA transmitter 102 and the OFDMA receiver 104 include other components that are commonly found in these types of devices. However, those other components are not described herein so that the inventive features of the HARQ system 106 are not obscured. In addition, although the HARQ system 106 is described herein with respect to an OFDMA wireless communication system, the HARQ system can be implemented in any OFDM-based wireless communication system.

In a HARQ mode, the OFDMA transmitter 102 is configured to send an OFDMA signal transmission with multiple HARQ entities over multiple frames. The term “HARQ entity” is commonly referred to as a “HARQ channel.” Thus, these terms are used interchangeably herein. The OFDMA receiver 104 is configured extract forward error correction (FEC) soft information bits from the received transmission. The HARQ system 106 of the OFDMA receiver 104 is configured to combine the current soft information bits with any previous soft information bits for corresponding HARQ entities to produce updated soft information bits, which are then decoded to check for errors. The HARQ system 106 then sends a feedback to the OFDMA transmitter 104 with respect to the received HARQ entities. In particular, the HARQ system 106 sends messages to instruct the transmitter for retransmission of the HARQ entities with decoding errors. These operations with respect to combining, decoding and sending feedbacks are performed by the HARQ processor 108.

Since current soft information bits of HARQ entities with error need to be combined with corresponding soft information bits in future retransmissions, the current soft information bits must be saved in the HARQ buffer 112. The buffer controller 110 controls the storing of soft information bits in the HARQ buffer 110, as well as the reading out the stored soft information bits from the HARQ buffer. As described in more detail below, the HARQ buffer 110 is managed to such that the buffer can handle any flexible size of HARQ entities, given a total size bound, with minimal overhead memory use.

Under the current WiMAX standard (i.e., IEEE 802.16e), a certain number of channels, say up to N_{ch}, is assigned to each mobile station, and each channel is reusable after decoding on that channel is successful. The number of soft information bits assigned to each channel is flexible, but the sum of the individual channel sizes cannot exceed certain upper bound, say K. Assuming that each soft bit set has N_{soft} bits, one buffering mechanism would be assigning N_{bit}=K*N_{soft} locations to each N_{ch} channel. But this simple technique requires too much memory space.

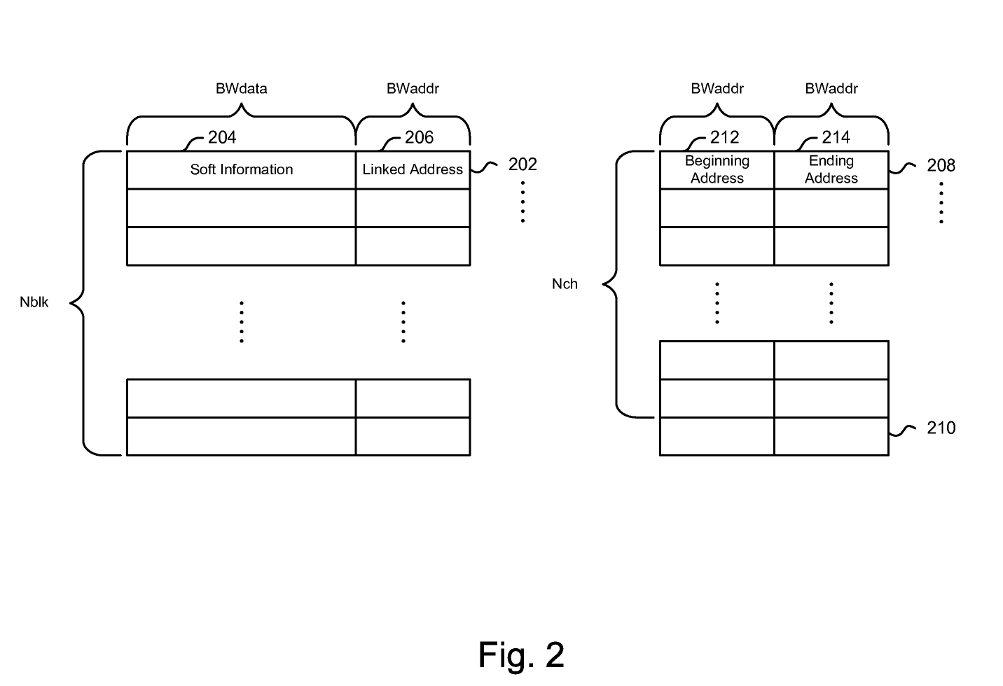

The buffer controller 110 employs a dynamic allocation and buffer management technique using a linked-list approach to efficiently use the HARQ buffer 112, which reduces the memory space requirement for the HARQ buffer. As illustrated in FIG. 2, which shows the data structure of the HARQ buffer 112, the HARQ buffer includes N_{blk} number of data memory blocks 202. Each of the data memory blocks 202 has a data portion 204 that is used to store a segment of soft information bits and an address portion 206 that is used to store a linked address, which is the address for the linked data memory block. The data portion 204 has a data bit width (BW_{data}) and the address portion 206 has an address bit width (BW_{addr}). The address bit width (BW_{addr}) can be calculated as the smallest integral value that is not less than (log 2 (N_{blk})), which can be expressed as ceil(log 2 (N_{blk})). In an embodiment, the data bit width (BW_{data}) for each data memory block 202 is chosen to be a power of 2 for each calculation of base address of each data memory block. However, in other embodiments, the data bit width (BW_{data}) for each data memory block 202 can be chosen differently for any reason. It can be shown that if the total number (N_{blk}) of the data memory blocks 202 is ceil(N_{bit}/BW_{data})+(N_{ch-1}), any combination of flexible channel sizes can be accommodated by the HARQ buffer 112.

The HARQ buffer 112 also includes N_{ch} number of address memory blocks 208 and an empty block address memory block 210. Each of the address memory blocks 208 and 210 has a beginning address portion 210 and an ending address portion 212. For each of the address memory blocks 208, the beginning address portion 212 is used to store the beginning address for soft information bits of an associated channel that are stored in one or more data memory blocks 202 and the ending portion 214 is used to store the ending address for the stored soft information bits. For the empty block address memory block 210, the beginning address portion 212 is used to store the beginning address for the data memory blocks 202 that are empty or unassigned, i.e., available for use, and the ending portion 214 is used to store the ending address for the empty data memory blocks. Although only a single empty block address memory block is shown in FIG. 2, the HARQ buffer 112 may include more than one empty block address memory block. With the data structure shown in FIG. 2, the overall size of the HARQ buffer 112 can be expressed as, buffer size=(BW_{data}*N_{blk})+(BW_{addr}*(N_{blk}+2*(N_{ch}+1))). The overhead ratio is the entire buffer size minus the number of soft information bits, divided by the number of soft information bits, i.e., (buffer size−N_{bit})/N_{bit}. Simulations can be used to find the optimal N_{blk} and BW_{data} that minimizes the overhead ratio.

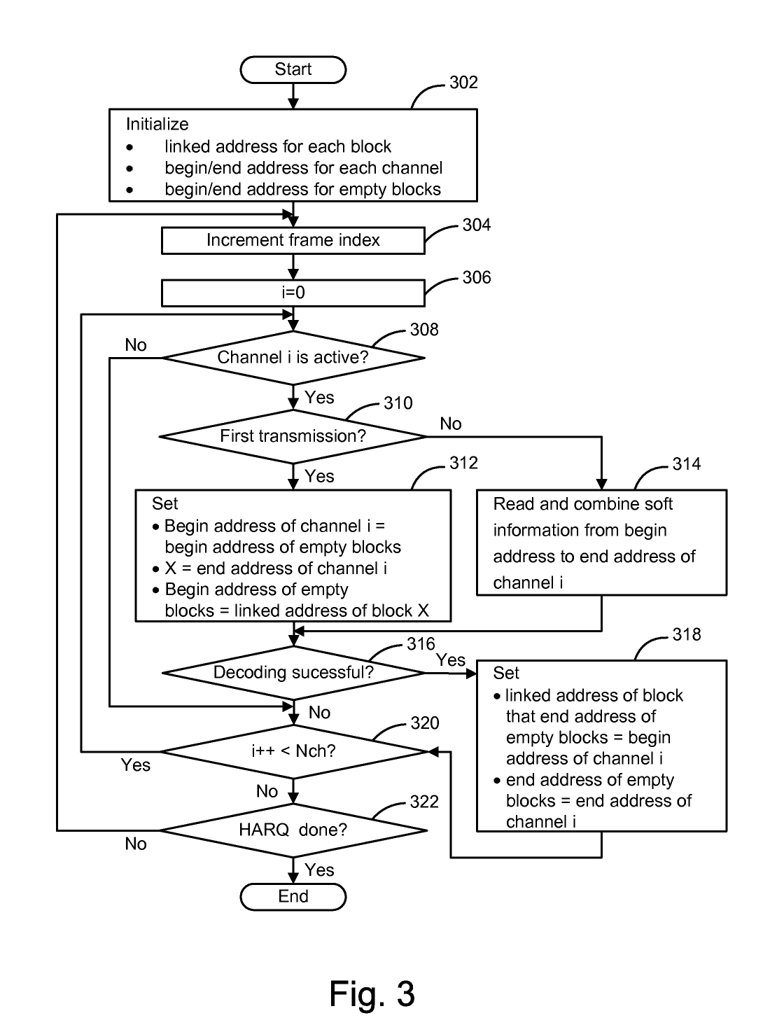

Turning now to FIG. 3, a process flow diagram of a HARQ buffer management method performed by the HARQ system 106 in accordance with an embodiment of the invention is shown. At step 302, link addresses for each data memory block 202, beginning and ending addresses for each channel, and beginning and ending addresses for empty data memory blocks are initialized. Table-I illustrates the initialization step in pseudocode.

TABLE I

```
To initialize linked-address array:
for (i=0;i<(Nblk−1);i++)
{
  linked_addr[i] = i+1;
}
linked_addr[Nblk−1] = −1;
To initialize beginning and ending addresses for each channel:
for (i=0;i<Nch;i++)
{
  ch_begin_addr[i] = −1;
  ch_end_addr[i] = −1;
}
To initialize beginning and ending addresses for empty data memory
blocks:
empty_begin_addr = 0;
empty_end_addr = Nblk−1;
```

Next, at step 304, a frame index is incremented. Next, at step 306, a channel number i is set to zero. Next, at step 308, a determination is made whether channel i is alive. If no, the process proceeds to block 320. If yes, then the process proceeds to step 310, where a determination is made whether the current transmission is the first transmission for this channel.

If this is not the first transmission for channel i, then the process proceeds to step 314, where soft information bits are read and combined from the beginning address and the ending address of channel i. The process then proceeds to step 316. However, if this is the first transmission for channel i, then process proceeds to block 312, where (a) the beginning address of channel i is set to the beginning address of empty data memory blocks, (b) X is set to the ending address of channel i, and (c) the beginning address of empty data memory blocks is set to linked address of data memory block X.

Next, at block 316, a determination is made whether the decoding was successful. If yes, then the process proceeds to step 318, where (a) the linked address of the data memory block that has the end address of the empty data memory blocks is set to the beginning address of channel i and (b) the ending address of the empty data memory blocks is set to the ending address of channel i. The process then proceeds to step 320. However, if the decoding was not successful, i.e., there was a decoding error, then the process proceeds directly to step 320, where the index i used for the channel identification is incremented and a determination is made whether the index i is less than the maximum number of channels, N_{ch}. If yes, then the process proceeds back to step 308. If no, then the process proceeds to step 322.

At step 322, a determination is made whether the HARQ operation is done. If no, then the process proceeds back to step 304. If yes, then the process comes to an end.

The soft information combining process in accordance with an embodiment of the invention, which is performed by the HARQ processor 108, is now described. The soft information combining process of the HARQ processor 108 uses a scaling factor, Sᵢ, which depends on channel state, automatic gain control (AGC) output, etc., for the transmission number i. The true soft information value at transmission number i, is represented as X̅ᵢ. The scaled soft information value at transmission number i, is Xᵢ=Sᵢ· X̅ᵢ. The combined soft information value for transmission number i, is represented as \tilde{X}ᵢ.

If there have been N number of transmissions on the same HARQ entity, the ideal combining rule would be \tilde{X}_{N}=f(S₁,S₂, . . . , S_{N},X₁,X₂, . . . , X_{N}), where f (arg1, arg2, . . . ) denotes a function that has a set of arguments inside the parenthesis. Thus, optimal combining requires that the receiving side stores all information on Sᵢ and Xᵢ for i=1,2, . . . , N, until decoding succeeds. However, as the number of retransmissions N grows, the requirement for storing all such information becomes impractical.

A combining rule used by the HARQ processor 108 is represented by, \tilde{X}_{N}=(\tilde{S}_{N-1},S_{N},\tilde{X}_{N-1},X_{N}), where \tilde{S}ᵢ indicates a combined scaling factor at a transmission number i. The HARQ processor 108 stores only the scaling factor and soft information that were updated at the previous transmission in the HARQ buffer 112 and the memory 114, respectively. Thus, the memory 114 only needs to store N_{ch} scaling factors for the N_{ch} HARQ entities. This yields a significant reduction in the amount of memory needed, e.g., a reduction by a factor of N can be achieved. Table-II provides a detail of such combining rule.

TABLE II

| | |
|---|---|
| If \tilde{S}_{N-1} > S_{N} | $\begin{matrix}{\tilde{X}}_{N} = ( α \cdot \frac{{S}_{N}}{{\tilde{S}}_{N - 1}} \cdot {X}_{N - 1} + {X}_{N} ) \cdot \frac{1}{β} \\ {\tilde{S}}_{N} = {S}_{N}\end{matrix}$ |
| Else | $\begin{matrix}{\tilde{X}}_{N} = ( α \cdot {X}_{N - 1} + \frac{{\tilde{S}}_{N - 1}}{{S}_{N}} \cdot {X}_{N} ) \cdot \frac{1}{β} \\ {\tilde{S}}_{N} = {\tilde{S}}_{N - 1}\end{matrix}$ |

In this combining rule, soft information bits from previous transmissions are scaled by α, which is a scalar value. The less confident information between previous and current transmissions is de-weighted. Combined soft information is then scaled by 1/β, where β is a scalar value. The combined scaling factor \tilde{S}ᵢ is updated with the one from the more confident transmission. For optimal combining, α=N−1 and β=N are used. For a sub-optimal combining, but with a simpler implementation, α=1 and β=2 can be considered.

The memory size requirement of the HARQ buffer 112 can be further reduced by dropping the less reliable pieces of soft information before that information is stored in the HARQ buffer. One technique is to truncate the least significant bits (LSB) of the soft information. Later, when the truncated soft information is used in combining, the truncated LSBs of the soft information from the HARQ buffer 112 are filled with zeros. This technique works well because the more significant part of the confidence level information is carried in the most significant bits (MSB) of the soft information.

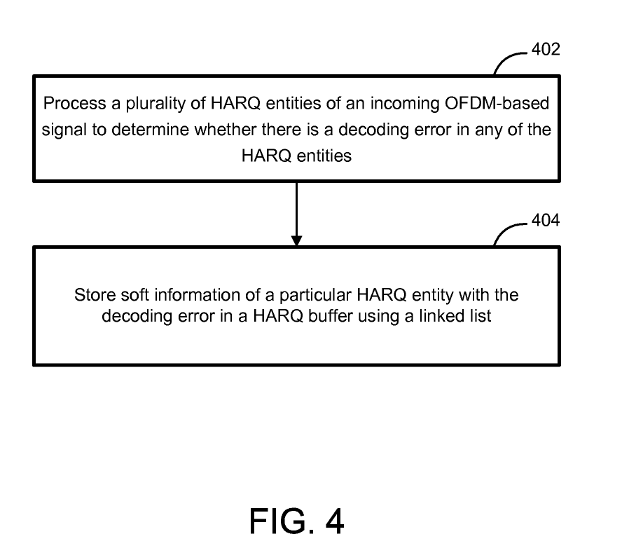

A method for performing a HARQ operation in an OFDM-based receiver in accordance with an embodiment of the invention is described with reference to a process flow diagram of FIG. 4. At block 402, a plurality of HARQ entities of an incoming OFDM-based signal is processed to determine whether there is a decoding error for any of the HARQ entities. At block 404, soft information of a particular HARQ entity with the decoding error is stored in a HARQ buffer using a linked list. The HARQ buffer includes a plurality of data memory blocks. Each of the data memory blocks includes a data portion to store a segment of the soft information bits and an address portion to store a linked address.

The processing of the plurality of HARQ entities may include combining the soft information of the particular HARQ entity with previous updated soft information of the particular HARQ entity using a combined scaling factor that depends on a current scaling factor and a previous combined scaling factor, which reduces the complexity of the process and memory requirement. In embodiment, at least some of the least significant bits of the soft information may be truncated before storing the soft information in the HARQ buffer, which further reduces the memory size requirement of the HARQ buffer.

Although specific embodiments of the invention have been mentioned, the invention is not limited to the specific forms or arrangements of parts that are described and illustrated here. The scope of the invention is defined by the claims presented herein and their equivalents.

What is claimed is:

1. A Hybrid Automatic Repeat Request (HARQ) system for an OFDM-based receiver comprising;
a HARQ processor that is configured to process a plurality of HARQ entities of an incoming OFDM-based signal to determine whether there is a decoding error in any of the HARQ entities;
a HARQ buffer operably connected to the HARQ processor, the HARQ buffer being used to store soft information of a particular HARQ entity with the decoding error, the HARQ buffer including a plurality of data memory blocks, each of the data memory blocks including a data portion and an address portion; and
a buffer controller operably connected to the HARQ buffer, the buffer controller being configured to store segments of the soft information in some of the data portions of the data memory blocks of the HARQ buffer and associated linked addresses in some of the address portions of the data memory blocks of the HARQ buffer.

2. The HARQ system of claim 1 wherein the HARQ buffer further includes address memory blocks for the HARQ entities to store a beginning address and an ending address for each soft information stored in the data memory blocks, the HARQ buffer further including at least one empty block address memory block to store another beginning address and another ending address for the data memory blocks that are available for use.

3. The HARQ system of claim 1 wherein the total size of the data memory blocks is ceil(N_{bit}/BW_{data})+(N_{ch}−1), where N_{bit} represents the number of bits for each soft information, BW_{data} represents the bit width of the data portions of the data memory blocks and N_{ch} represents the number of assigned HARQ entities.

4. The HARQ system of claim 1 wherein the HARQ processor is configured to combine the soft information of the particular HARQ entity with previous updated soft information of the particular HARQ entity using a combined scaling factor that depending on a current scaling factor and a previous combined scaling factor.

5. The HARQ system of claim 4 wherein the HARQ processor is configured to combine the soft information of the particular HARQ entity with previous updated soft information of the particular HARQ entity using
\tilde{X}_{N}=f(\tilde{S}_{N-1},S_{N},\tilde{X}_{N-1},X_{N})
where N represents the number of transmissions for the particular HARQ entity, \tilde{X}_{N} represents combined soft information at current transmission, \tilde{X}_{N-1} represents combined soft information at previous transmission, \tilde{S}_{N-1} represents a combined scaling factor at the previous transmission, S_{N} represents a scaling factor at the current transmission and X_{N} represents a scaled soft information at the current transmission.

6. The HARQ system of claim 5 wherein the HARQ processor is configured to combine the soft information of the particular HARQ entity with previous updated soft information of the particular HARQ entity using the following combining rule:
$$if {\tilde{S}}_{N - 1} > {S}_{N}$$
$${\tilde{X}}_{N} = ( α \cdot \frac{{S}_{N}}{{\tilde{S}}_{N - 1}} \cdot {X}_{N - 1} + {X}_{N} ) \cdot \frac{1}{β}$$
$${\tilde{S}}_{N} = {S}_{N}$$
$$else , \\ {\tilde{X}}_{N} = ( α \cdot {X}_{N - 1} + \frac{{\tilde{S}}_{N - 1}}{{S}_{N}} \cdot {X}_{N} ) \cdot \frac{1}{β} , \\ {\tilde{S}}_{N} = {\tilde{S}}_{N - 1}$$
where α and β are scalars, X_{N-1} represents a scaled soft information at the previous transmission number and \tilde{S}_{N} represents a combined scaling factor at the current transmission.

7. The HARQ system of claim 6 wherein α and β are set to 1 and 2, respectively.

8. The HARQ system of claim 6 wherein α and β are set to N−1 and N, respectively.

9. The HARQ system of claim 1 wherein the HARQ processor is configured to truncate at least some least significant bits of the soft information before storing the soft information in the HARQ buffer.

10. A method for performing a Hybrid Automatic Repeat Request (HARQ) operation in an OFDM-based receiver comprising;
processing a plurality of HARQ entities of an incoming OFDM-based signal to determine whether there is a decoding error in any of the HARQ entities; and
storing soft information of a particular HARQ entity with the decoding error in a HARQ buffer using a linked list, the HARQ buffer including a plurality of data memory blocks, each of the data memory blocks including a data portion to store a segment of the soft information bits and an address portion to store a linked address.

11. The method of claim 10 further comprising:
storing a beginning address and an ending address for each soft information stored in the data memory blocks; and
storing another beginning address and another ending address for the data memory blocks that are available for use.

12. The method of claim 11 wherein the beginning and ending addresses are stored in address memory blocks for the HARQ entities in the HARQ buffer and wherein the another beginning and ending addresses are stored in an empty block address memory block in the HARQ buffer.

13. The method of claim 10 wherein the total size of the data memory blocks is ceil(N_{bit}/BW_{data})+(N_{ch}−1), where N_{bit} represents the number of bits for each soft information, BW_{data} represents the bit width of the data portions of the data memory blocks and N_{ch} represents the number of assigned HARQ entities.

14. The method of claim 10 further comprising combining the soft information of the particular HARQ entity with previous updated soft information of the particular HARQ entity using a combined scaling factor that depending on a current scaling factor and a previous combined scaling factor.

15. The method of claim 14 wherein the combining includes combining the soft information of the particular HARQ entity with previous updated soft information of the particular HARQ entity using
\tilde{X}_{N}=f(\tilde{S}_{N-1},S_{N},\tilde{X}_{N-1},X_{N})
where N represents the number of transmissions for the particular HARQ entity, \tilde{X}_{N} represents combined soft information at current transmission, \tilde{X}_{N-1} represents combined soft information at previous transmission, \tilde{S}_{N-1} represents a combined scaling factor at the previous transmission, S_{N} represents a scaling factor at the current transmission and X_{N} represents a scaled soft information at the current transmission.

16. The method of claim 15 wherein the combining includes combining the soft information of the particular HARQ entity with previous updated soft information of the particular HARQ entity using the following combining rule:
$$if {\tilde{S}}_{N - 1} > {S}_{N}$$
$${\tilde{X}}_{N} = ( α \cdot \frac{{S}_{N}}{{\tilde{S}}_{N - 1}} \cdot {X}_{N - 1} + {X}_{N} ) \cdot \frac{1}{β}$$
$${\tilde{S}}_{N} = {S}_{N}$$
$$else , \\ {\tilde{X}}_{N} = ( α \cdot {X}_{N - 1} + \frac{{\tilde{S}}_{N - 1}}{{S}_{N}} \cdot {X}_{N} ) \cdot \frac{1}{β} , \\ {\tilde{S}}_{N} = {\tilde{S}}_{N - 1}$$
where α and β are scalars, X_{N-1} represents a scaled soft information at the previous transmission number and \tilde{S}_{N} represents a combined scaling factor at the current transmission.

17. The method of claim 16 wherein α and β are set to 1 and 2, respectively.

18. The method of claim 16 wherein α and β are set to N−1 and N, respectively.

19. The method of claim 10 further comprising truncating at least some least significant bits of the soft information before storing the soft information in the HARQ buffer.
